(19) United States
(12) Patent Application Publication
(10) Pub. No.: US 2008/0257651 A1
(43) Pub. Date: Oct. 23, 2008

(54) LIFT TRUCK WITH PRODUCTIVITY ENHANCING PACKAGE INCLUDING VARIABLE TILT AND VERTICAL MASTING

(76) Inventor: Joel L. Williamson, Georgetown, KY (US)

Correspondence Address: KING & SCHICKLI, PLLC, 247 NORTH BROADWAY, LEXINGTON, KY, 40507, US

(21) Appl. No.: 12/105,631

(22) Filed: Apr. 18, 2008

Related U.S. Application Data
(60) Provisional application No. 60/925,812, filed on Apr. 23, 2007.

(51) Int. Cl. B66F 9/20; B66F 9/08

(52) U.S. Cl. 187/224; 187/226

(57) ABSTRACT

Methods and apparatus contemplate a variable mast tilting feature that restricts mast tilt speeds and tilt ranges at a time when the forks are relatively high. Conversely, when the forks are low, no restrictions exist other than operating set-points. A High/Low switch on the mast determines when the forks are high or low. A tilt angle sensor (preferably a linear actuator on the tilt cylinder) determines the amount of mast tilt. A vertical masting feature automatically makes a mast substantially perpendicular to the ground. Activation of a vertical function change button, in combination with an activated tilt lever, causes the mast to upright itself (in either the forward or reverse directions of movement). Also, if the mast is relatively high, the speed of mast “uprighting” will be relatively slower than if the mast is relatively low. Hydraulic and electric circuit diagrams, to name a few, are also disclosed.

This application claims priority and benefit of U.S. Provisional application Ser. No. 60/925,812, filed Apr. 23, 2007, entitled “LIFT TRUCK WITH PERFORMANCE ENHANCING PACKAGE INCLUDING VALUABLE TILT AND VERTICAL MAST.” Its contents are incorporated herein in their entirety.

### FIELD OF THE INVENTION

The present invention relates generally to lift trucks, such as fork lifts. More particularly, although not exclusively, the invention relates to fill and restricted tilt ranges depending on fork height, including limitations on fork tilt-speed. Orienting the upright vertically is another noteworthy feature. Also, all features may be commonly used in a single truck.

### BACKGROUND OF THE INVENTION

Although the art of lift trucks has been established for some time, heretofore, manufacturers have avoided imposing tilt speed and tilt range restrictions per fork height. In turn, operators must be highly skilled to always properly maneuver loaded forks regardless of height. Also, making a mast vertically uptight, for ease of insertion into shelving racks, for instance, has been contingent upon the skills of an operator, which may not always be adequate.

Accordingly, a need exists in the art of lift trucks to impose speed and tilt restrictions based on fork height. Also, a need exists to automatically make the mast vertical, alone and in combination with the speed/tilt restrictions. Any improvements along such lines should further contemplate good engineering practices, such as stability, ease of implementation, flexibility, etc.

### SUMMARY OF THE INVENTION

The foregoing and other problems become solved by applying the principles and teachings associated with the hereinafter-described lift truck with productivity enhancing package including variable mast tilt and vertical masting. At a high level, the features of the variable mast tilt include restricting mast tilt speeds and tilt ranges Forward (F) and Backward (B) at a time when the upright or forks are relatively high (away from the ground). At a time when the upright or forks are relatively low, or close to the ground, conversely, there is no restriction on mast tilt speeds or tilt ranges (other than those imposed as general operating conditions of the truck).

In the restricted embodiment, forks 59 inches above the ground, preferably, enable mast tilts between five degrees backward and three degrees forward and are enabled to move at a relatively slow speed. Speed, in a representative embodiment, is measured in hydraulic fluid flowing to the tilt cylinder and at a speed of about 1.5-2 gallons per minute (gpm). (Skilled artisans will appreciate, however, speed could be measured in upright movement in feet per minute, for example.) In the unrestricted embodiment, the forks are within 59 inches of the ground and the mast is enabled to fully tilt in a range of eight degrees backward and six degrees forward and at a regularly fast tilting speed, such as at hydraulic flow of 4-4.5 gpm. A High/Low switch on the mast determines when the forks cross above or below 59 inches from the ground. A tilt angle sensor (preferably a linear actuator on the tilt cylinder) determines the amount mast tilt per various voltage readings.

Appreciating the 59 inch limitation is representative, and corresponds to a particular lift truck of the type, such as a three-stage 188 inch max fork height (mfh) truck, other high/low determinations are possible. For instance, a three-stage 238 inch mfh lift truck is anticipated at having the restricted embodiment begin when the forks are at 79 inches above the ground, or higher, while a four-stage 240 inch mfh lift truck is anticipated at having the restricted embodiment also begin at 59 inches. The backward and forward tilting ranges will also vary.

The vertical masting feature, on the other hand, relates to automatically making a mast substantially perpendicular to the ground. In this manner, the forks are easier to insert into and pull out of shelving racks, for example. In the past, forklift operators had to adjust the forks manually, via control levers and the mast did not always sit upright. In a preferred embodiment, the functionality includes an activation device (e.g., function change button) such that upon activation and in combination with an operator activating the tilt lever, the mast will upright itself (in either the forward or reverse movement directions). Upon achieving an upright or perpendicular position, the mast movement stops. Naturally, if the mast is relatively high (e.g., the forks are well above the ground and in a restricted range of movement) the speed of mast “uprighting” will be relatively slower than if the mast is relatively low (e.g., the forks are closer to the ground, and unrestricted).

These and other embodiments of the present invention will be set forth in the description which follows, and in part will become apparent to those of ordinary skill in the art by reference to the following description of the invention and referenced drawings or by practice of the invention. The claims indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative lift truck having variable tilting and vertical masting functionality;

FIG. 2 is a diagrammatic view in accordance with the present invention of a more detailed operator compartment of the truck of FIG. 1;

FIG. 3 is a diagrammatic view in accordance with the present invention of a more detailed visual display unit of the operator compartment of FIG. 2;

FIGS. 4A-4E are diagrammatic views in accordance with the present invention corresponding to a representative multi-function control handle for an operator and manipulation thereof;

FIGS. 5A and 5B are diagrammatic views in accordance with the present invention of a representative full and restrictive operating ranges for the truck;

FIG. 6 is a diagrammatic view in accordance with the present invention of another representative manipulation for the multi-function control handle;

FIGS. 7 and 8 are diagrammatic views in accordance with the present invention of a Variable Mast Tilt Example showing a first representative example for a lift truck whereby a forward tilt threshold equals a vertical mast position;

FIGS. 8 and 9 are diagrammatic views in accordance with the present invention of a Variable Mast Tilt Example showing a second representative example for a lift truck whereby a forward tilt threshold and vertical mast position are different;

FIG. 11 is a diagrammatic view in accordance with the present invention of a Tilt Sensor Management profile relative to programming a processor for controlling a tilt sensor;

FIG. 12 is a diagrammatic view in accordance with the present invention of a pump control relative to programming a processor for controlling same;

FIG. 13 is a diagrammatic view in accordance with the present invention of a representative hydraulic diagram of a lift truck;

FIGS. 14 and 15 are diagrammatic views in accordance with the present invention of a representative wiring diagram of a lift truck;

FIG. 16 is an engineering view in accordance with the present invention of a representative mast portion and height switch for sensing high and low fork positions; and

FIG. 17 is a graph in accordance with the present invention of the pump/tilt speed versus the angle of the tilt sensor of a representative lift truck.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for a lift truck having productivity packaging, including variable tilt and vertical masting, are hereinafter described.

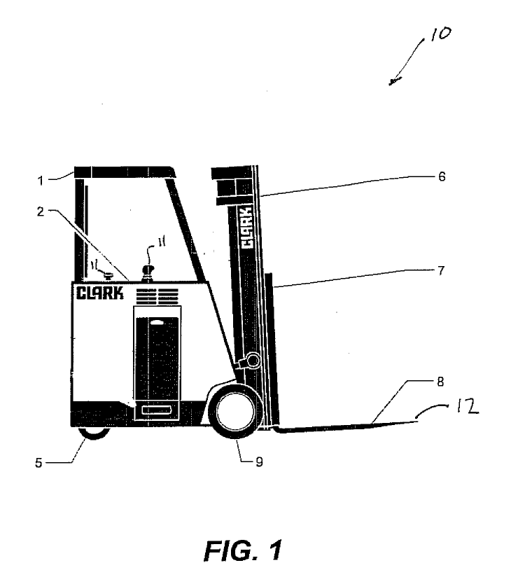

With reference to FIG. 1, a representative lift truck is given as 10. It operates, as is typical, via input from a human operator (not shown) in a compartment 2 protected by an overhead guard 1. During use, the operator manipulates various controls 11 to cause loads positioned on forks 8 and backrest 7 to become raised or lowered, as the case may be, relative to shelves, for instance. An upright stage 6 raises or lowers to move the forks 8 up or down. It may also telescope whenever the forks are raised above a predetermined height (a height sensor is also employed). During lowering, the opposite occurs. The truck moves forward and reverse across the ground via a pair of drive wheels 9 and steer wheels 5. It also rotates clockwise and counterclockwise to pivot the forks into position and for purposes of steering.

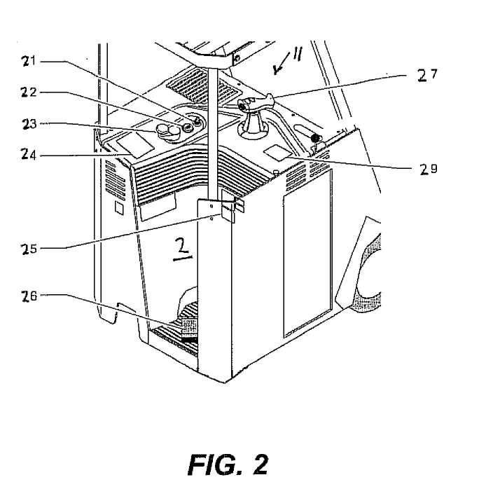

With reference to FIG. 2, the controls 11 include a visual display unit 22 for use in providing immediate operating conditions of the truck and to diagnose truck problems, to name a few. A steering tiller 23 and multi-function control handle 27 are also provided and are the primary items for steering and manipulating both the truck and the forks. Other elements include a key switch 21 for tuning the truck on and off as well as a parking brake 26. A name/data plate 25 and various decals 24 and 29 may also be used to provide visual truck specifications and instructions to the operator.

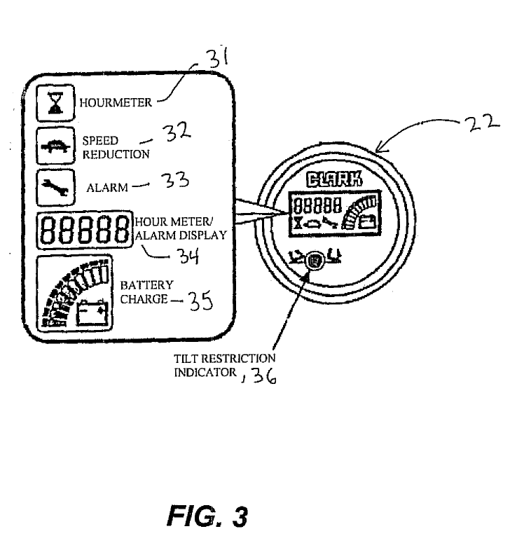

With reference to FIG. 3, the visual display unit 22 further includes display readouts for: a scale of usable charge 35 left on a battery (or other gas gauge function); speed reduction 32 and an LED 36 or other alarm or light that indicates when the fork tilt is outside of a restricted range (described below, including reference to the LED as an MDI or tilt restriction indicator). Also, the operating hours registered on the truck will appear in a display 34 as well as various alarm codes, depending upon mode of usage. In turn, the hourglass meter 31 will illuminate when the mode of usage corresponds to the hours while the wrench alarm 33 will illuminate when the mode of usage corresponds to alarm codes (e.g., fault or diagnostic codes).

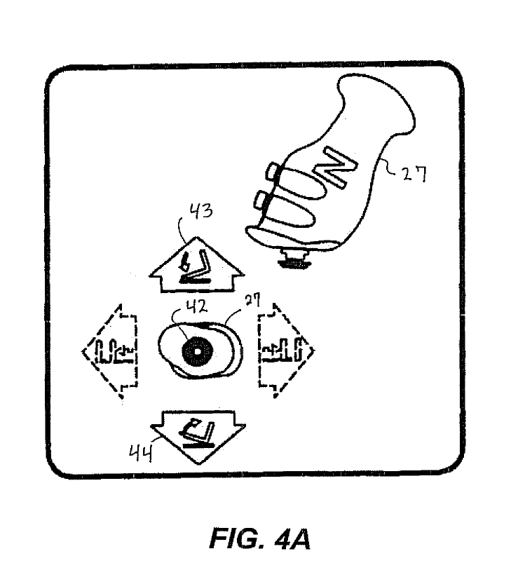

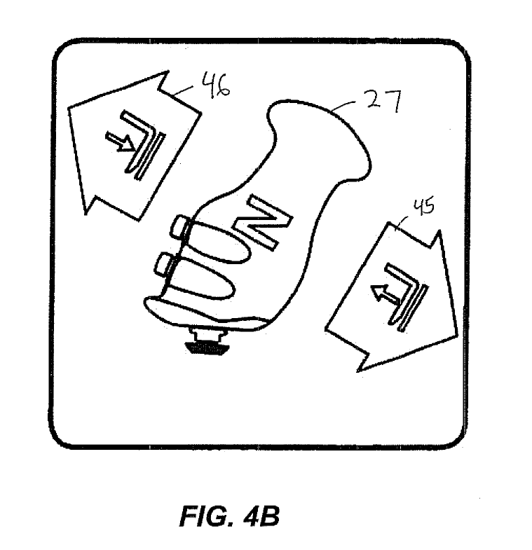

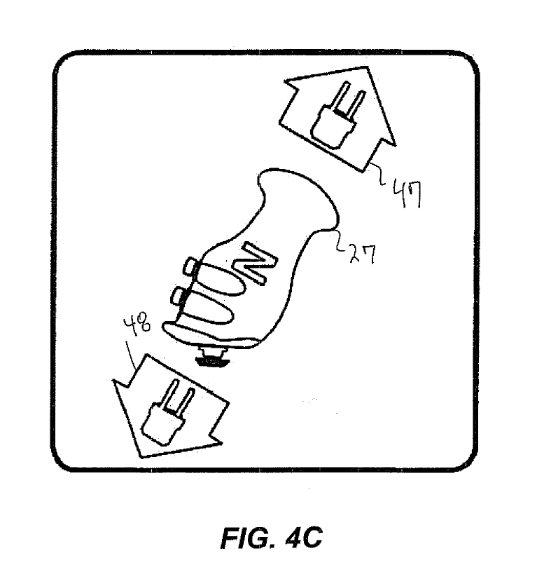

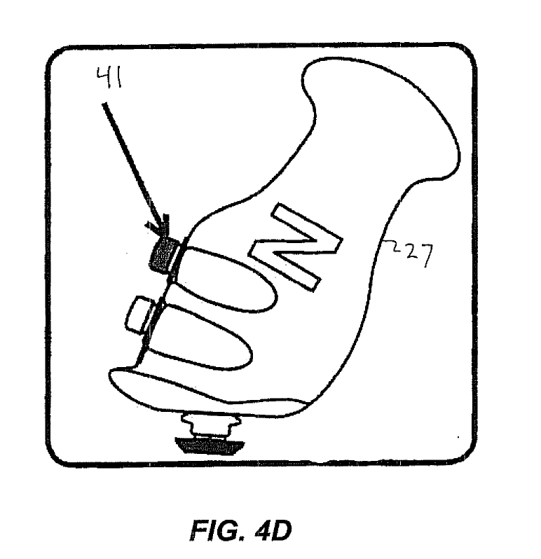

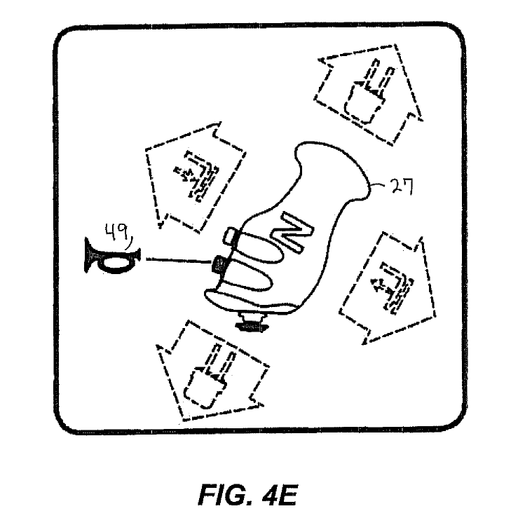

With reference to FIGS. 4A-4E, the multi-function control handle 27, as its name implies, enables many operator functions from a single handle depending upon manipulation. To tilt the forks, the control handle includes a miniature joystick 42 on its side that is manipulated upward 43 to tilt the forks tips-down and downward 44 to tilt the forks tips-up. (The tips being shown in FIG. 1 at 12 and the mast or upright 6 being manipulated forward or backward concurrent with the fork tilting.) To raise or lower the forks (e.g., raise or lower the upright) the control handle 27 is pulled backwards 45 or pushed forward 46, respectively. If the tilt restriction indicator 36 (FIG. 3) is illuminated, it indicates the upright is outside of a suitable operating area and will only raise to a predetermined height. Tilting the mast to a vertical position will then enable the raising of the forks above the predetermined height.

To drive the truck either forward or backward, the operator moves the control handle 27 toward the front of the truck 47 (to the operator's right) or toward the back or rear of the truck 48 (to the operator's left), respectively. The farther the control handle is moved, to either the right or left, the faster the truck will travel in its given direction (forward or reverse). At 41, a function change button is provided (typically where an operator's middle finger rests) that, when depressed, controls a fork leveling function and an Auxiliary Valve 2 function, if equipped (both described below). At 49, a horn button is also provided.

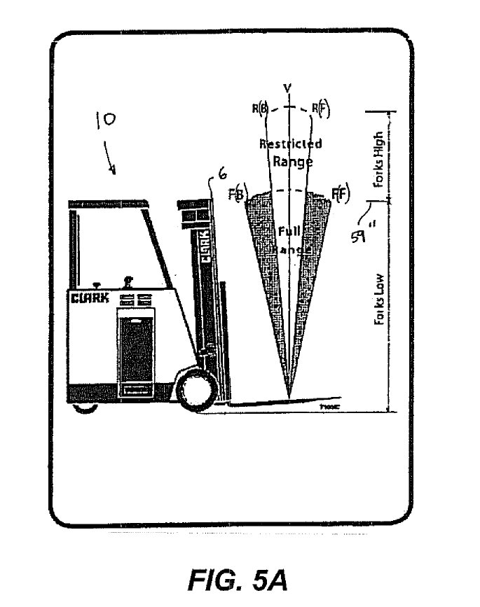

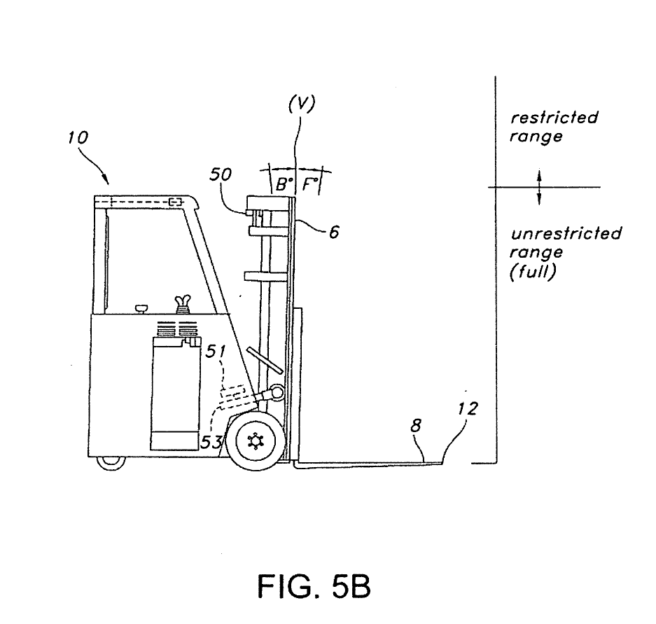

With reference to FIGS. 5A and 5B, a truck 10 has a variable mast tilt feature that restricts mast tilting speeds and tilting ranges Forward (F) and Backward (B) (relatively to vertical (V)) at a time when the upright or forks are relatively high (away from the ground). At a time when the upright or forks are relatively low, or close to the ground, conversely, there is no restriction on mast tilt speeds or tilt ranges (other than general operating set-points of the truck).

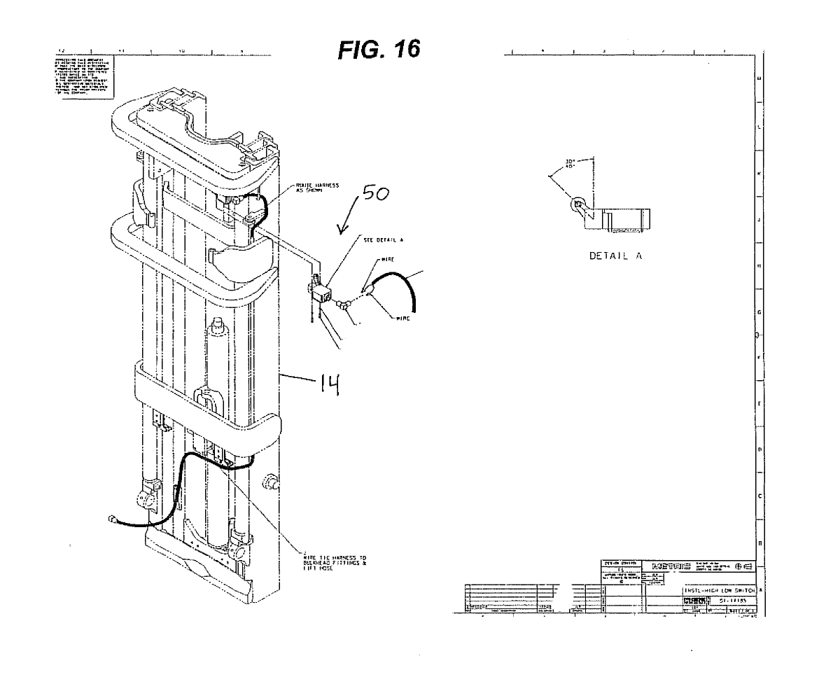

As before, in the restricted embodiment, forks above the ground in an amount such as 59 inches, or above, enable mast tilts between five degrees backward and three degrees forward and are enabled to tilt at a relatively slow speed, e.g., 1.5-2 gpm. In the unrestricted embodiment, the forks are within 59 inches of the ground (Forks low) and the mast is enabled to fully tilt in a range of eight degrees backward and six degrees forward and at a regularly fast tilting speed, e.g., 4-4.5 gpm. A High/Low switch or sensor (e.g., hydraulic switch, electro-mechanical switch, etc. 50, also FIG. 16) on the mast determines when the forks cross above or below the critical height, e.g., 59 inches from the ground. A tilt angle sensor (preferably a linear actuator 51 on the tilt cylinder 53) determines the amount mast tilt per various voltage readings. Of course, other height and tilt sensors and parameters are possible.

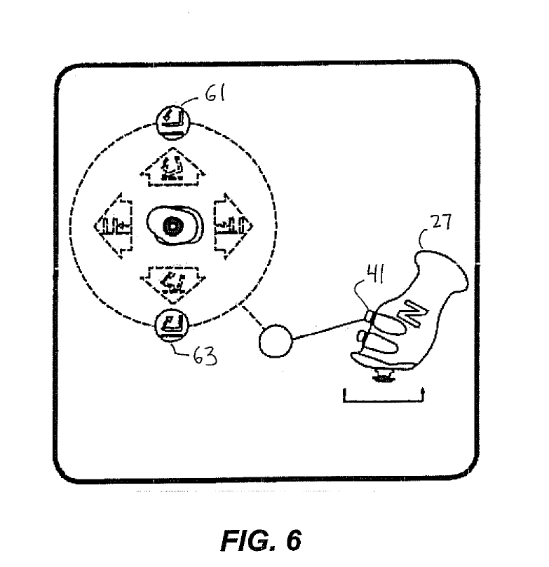

A vertical mast feature of the truck 10, on the other hand, relates to automatically making the mast substantially perpendicular to the ground. In this manner, the forks are easier to insert into and pull out of shelving racks, for example. In a preferred embodiment, the functionality includes a vertical masting activation device, e.g., button 41, FIG. 6A (alternatively named the “function change button” 41 in FIG. 4D), such that, upon activation, and in combination with an operator activating the control handle 27 in a forward or backward tilting function (e.g., FIG. 4A), the mast 14 will upright itself (in either a forward tilting 61 or reverse tilting 63 direction of movement) to a vertical position substantially perpendicular to ground. Upon achieving an upright or perpendicular position, the mast movement will stop. Naturally, if the mast is relatively high (e.g., the forks are well above the ground) the speed of mast “uprighting” will be relatively slower than if the mast is relatively low (e.g., the forks are closer to the ground, less than 59 inches). (Intuitively, the vertical upright position can be determined by a specific voltage reading, plus an appropriate tolerance range, of the tilt sensor on the tilt cylinder.)

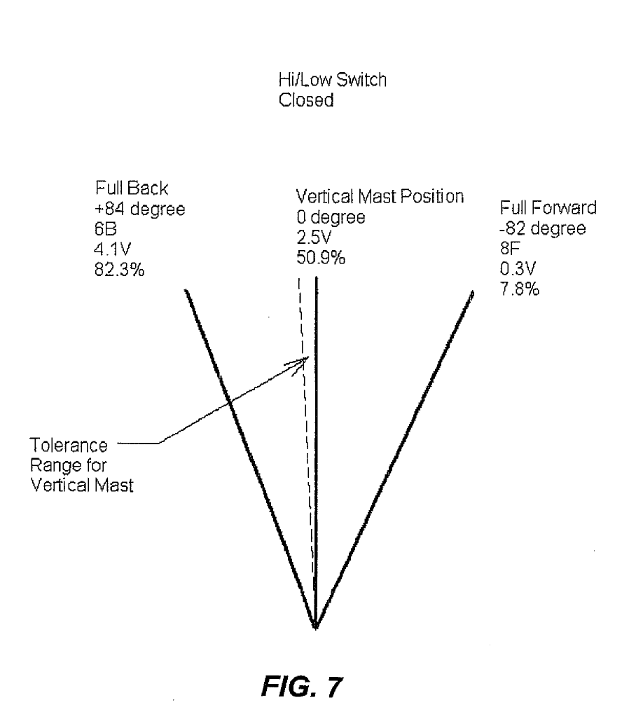

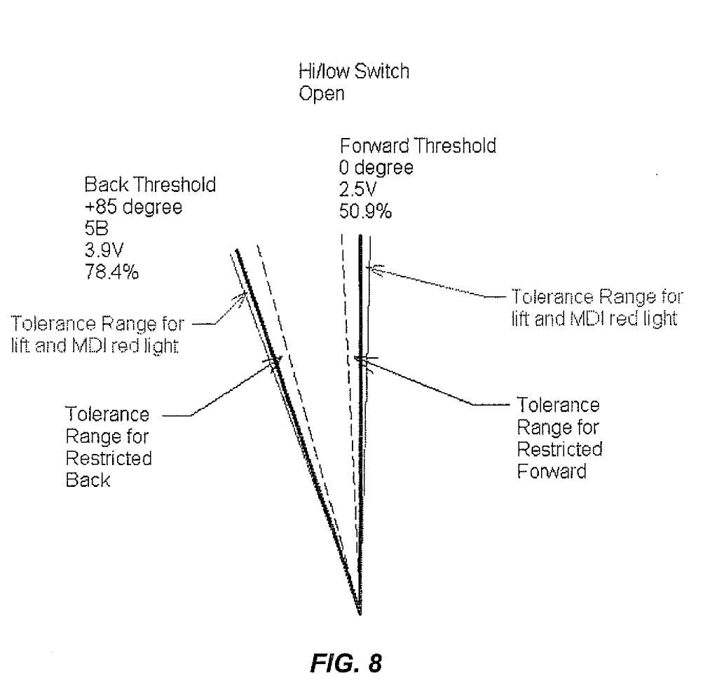

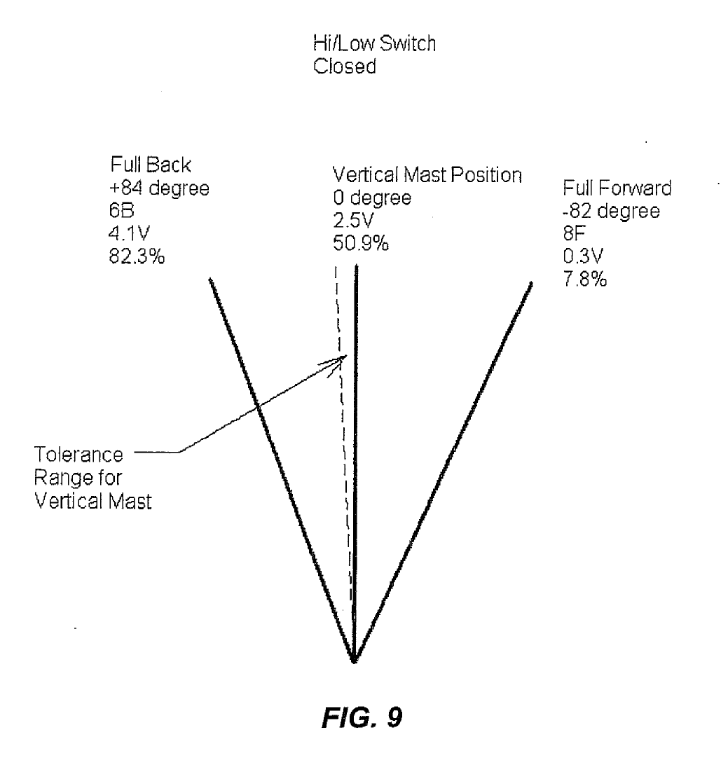

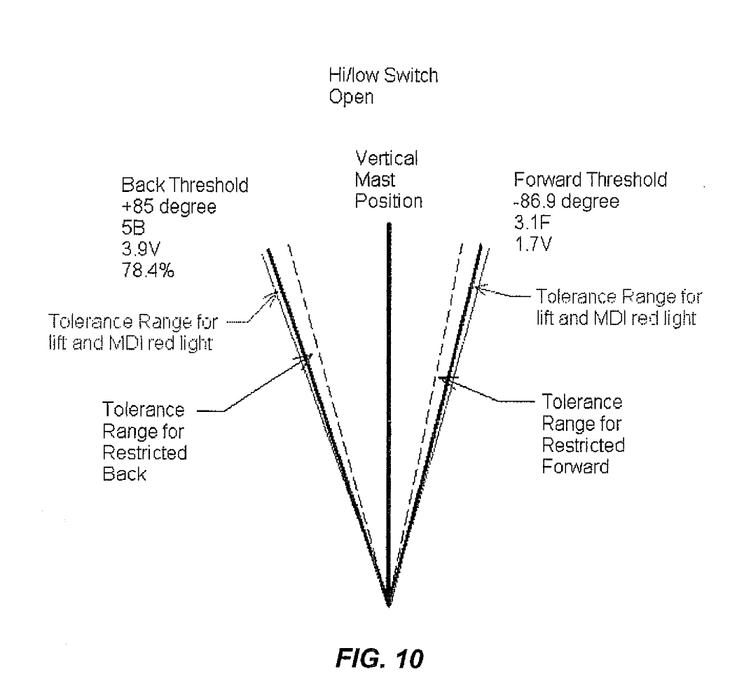

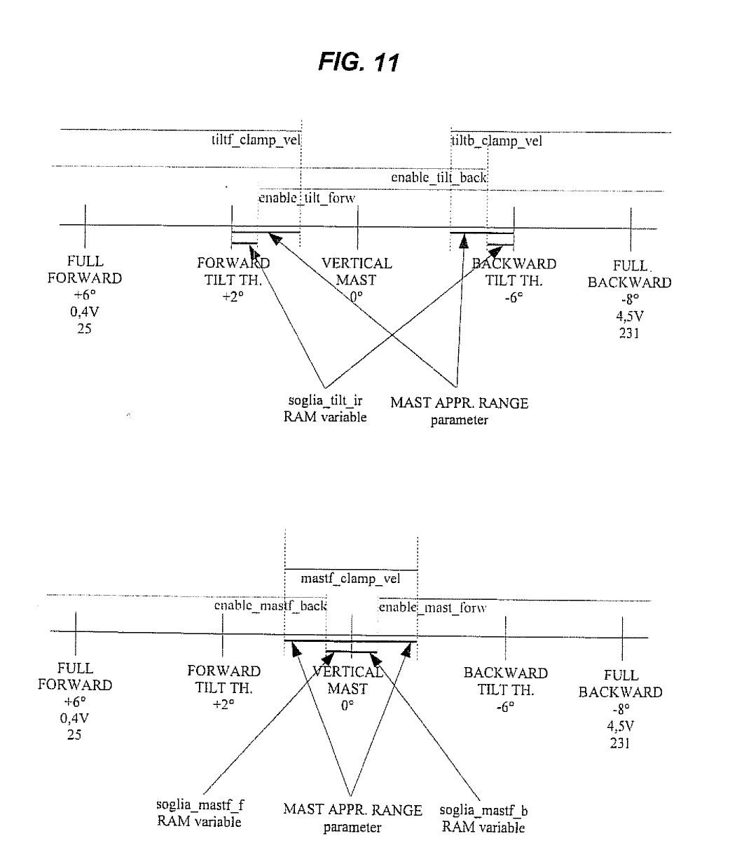

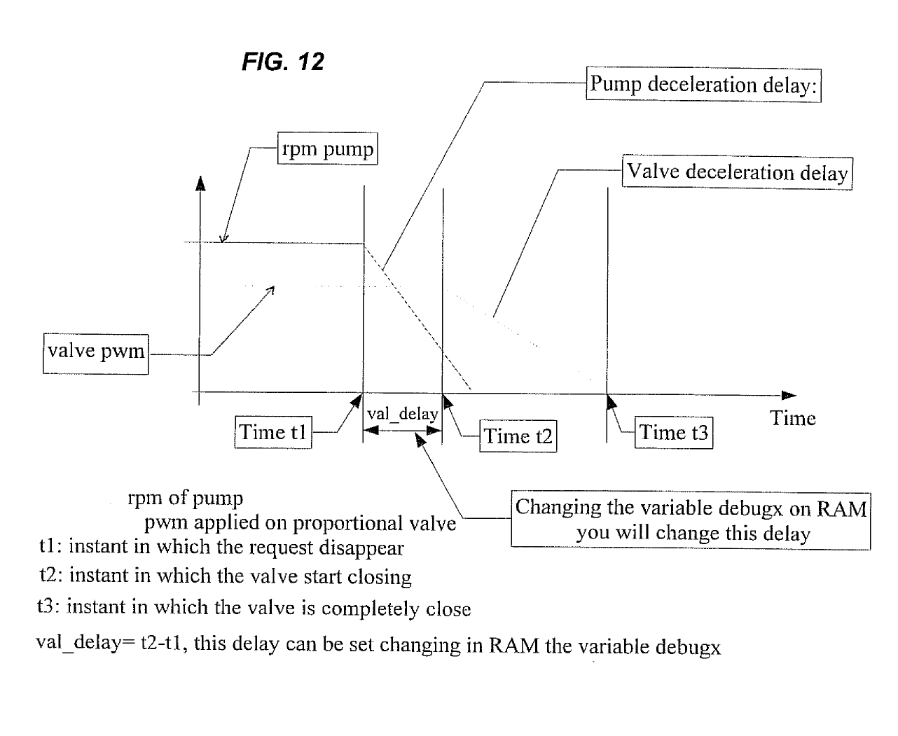

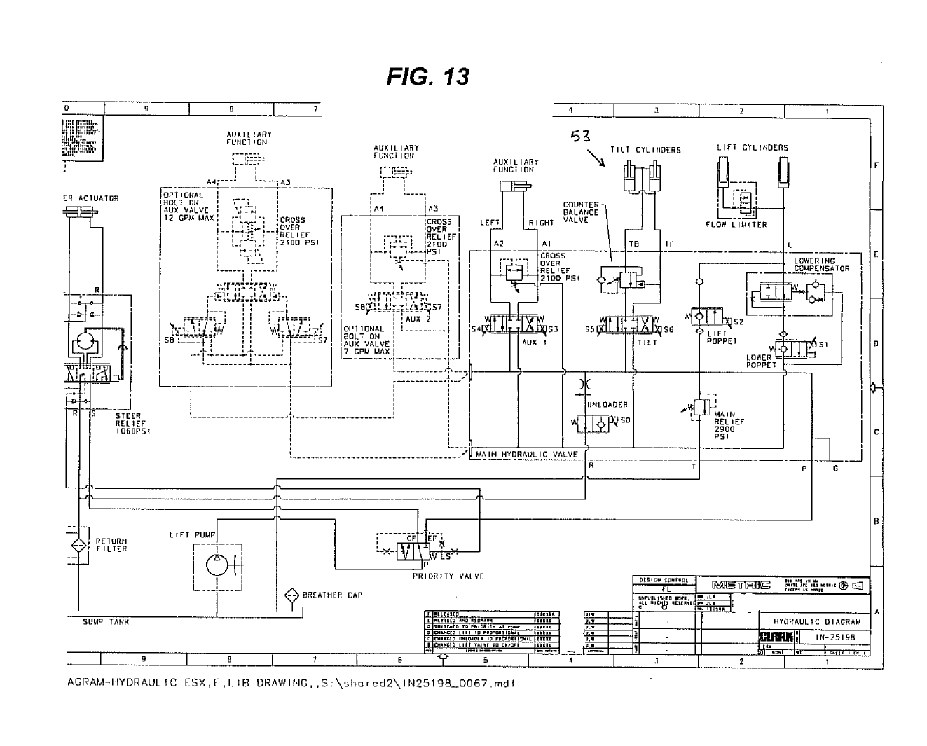

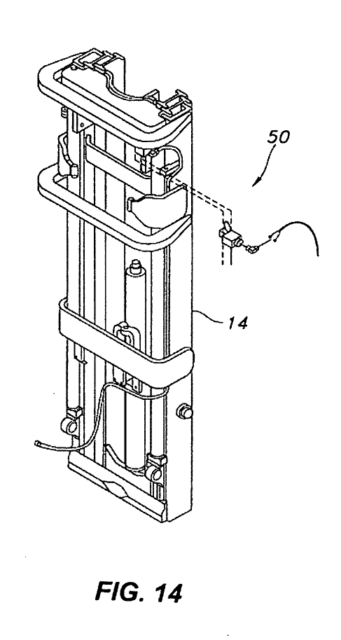

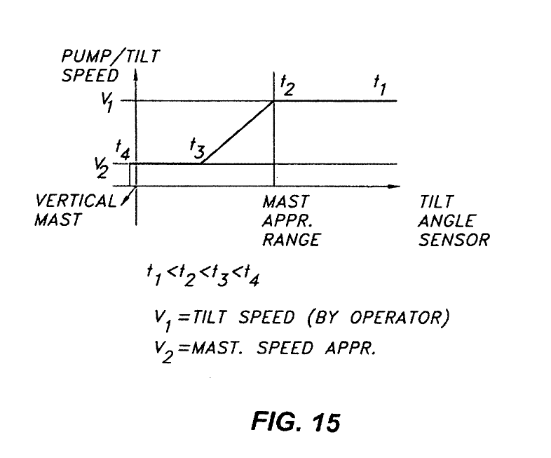

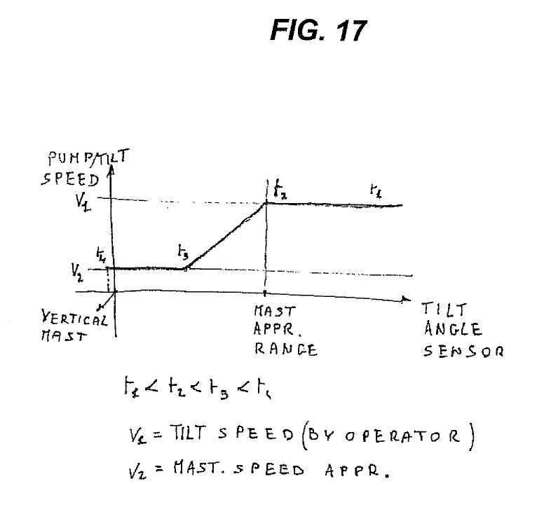

In alternate embodiments, versions of the above theme are contemplated for various forklifts, such as per two, three or even four stage masts that are well known in the art. (Regardless of stage, all trucks are expected to have normally 8 degrees back (B) and 6 degrees forward (F) when in a Forks Low condition. However, when high, some three-stage trucks are expected to have restricted 5B and 3F, while one four-stage truck is expected to have 3B and 0F.) (In either, fork lowering speed is expected up to 105 fpm (feet per minute) when unloaded and up to 100 fpm when loaded, with adjustability between 70 and 105 fpm being preferred.)) Tolerance issues are also expected to make a difference per tilt angle or speed, such as by way of mechanical stops or voltage signals per sensors, and both are exemplified in FIGS. 7-12, and 17. A controller (shown largely as one or more of ASIC's, collection of discrete chips, firmware, software, combinations of the foregoing, etc.) coordinates the above-described mast functionality in combination with hardware components (e.g., hydraulic pump(s), tilt sensor(s), tilt cylinders), (high/low) height sensor(s), mast, etc.) as exemplified in FIGS. 13-15.

### Example

FIGS. 7-10 show backward tilting (in degrees) as positive while forward tilting is negative. They are provided for reference and show two illustrations of acquired positions in degrees, volts from tilt sensor, and percentage read by a tester menu in pump controller. Further: the forward threshold can be set equal to the vertical mast; the backward threshold can be set equal to the full back (FB); the FB must be greater than or equal to the backward threshold; the backward threshold must be greater than the vertical mast; the vertical mast must be greater than or equal to the forward threshold; and the forward threshold must be greater than full forward (FF).

### Logic:

Fast tilt speeds when high/low switch is closed (mast-Forks Low).

Slow tilt speeds when high/low switch is open (mast-Forks High)

Full tilt range when mast low.

Restricted tilt range (between forward threshold & back threshold) when mast is high.

MDI light is on if mast is outside restricted tilt range.

Lift should not work if mast is high and tilt is outside of restricted range.

If operator has tilt outside of restricted range while mast is low and then lifts until mast is high. Controller stops fork lift movement. Operator should be able to tilt the mast only in the direction to get the mast back into the restricted range. Once the mast is back within restricted range, lift should move properly.

In the situation where the back threshold is set equal to full back, the MDI light should never come on when tilt is full back. Lift should always work in full back position.

Vertical Mast feature can be used whether mast is high or low. When forward threshold is set equal to vertical mast, then operator should not have to use the vertical mast feature, when high, since forward tilt will automatically stop at vertical mast when mast is high in this case.

Vertical Mast is engaged by pressing and holding the function change button on the joystick. Tilt should stop at vertical mast (within tolerances) whether forward tilting or back tilting if function change button is held.

If the operator is holding function change button while tilting and then releases while still tilting, the controller stops tilt and restarts tilt only after tilt lever (control handle) is returned to neutral. This keeps the operator from accidentally tilting while using the vertical mast feature due to premature button release. The same is tire for the function change button when operating the auxiliary (aux.) functions. So that one aux. attachment is not accidentally engaged when the operator is using aux. 2 by holding function change button and operating mini joystick to left or light and then releases the function change button prematurely. Controller should not allow aux. 1 to work if function change button is released while aux. 2 is engaged. User must return mini joystick to neutral.

### Tolerance Ranges:

The acquired positions could be programmed at degrees different than this example. But, the rules below refer to degrees and back tilt area versus forward tilt area. Obviously, if the vertical mast position was acquired in the forward tilt area, then the rules below would change accordingly.

It is preferred that the over/under run tolerances are as small as possible, but a tolerance range totaling 0.3 degrees would be acceptable.

When using vertical mast feature from fill forward tilt, the upright should stop at die acquired vertical mast position (0 degree) or slightly past into the back tilt area (positive area). This should never, preferably, stop in the forward tilt area (negative area).

When using vertical mast feature from full back tilt, the upright should stop at the zero degree or slightly before. Therefore, the tilt would stop in the back tilt area (positive).

When the mast is high (switch open) and back tilting, the upright should stop at the back threshold or before. This should never stop past the back threshold value.

When the mast is high (switch open) and forward tilting, the upright should stop at the forward threshold or before. This should never stop past the forward threshold value.

The red MDI light should only be on if the upright is outside of the acquired back threshold and forward threshold. In order to account for loaded versus unloaded conditions that cause the tilt cylinder to stroke slightly due to pressure change, the red light will need a tolerance just outside the acquired forward threshold (towards 0V) and a tolerance just outside the back threshold (toward 5V). This tolerance range should not be greater than 0.2 degree. This will only be needed if the tilt actually stops exactly on one of the acquired positions.

Fork lifting should be allowed if the mast switch is open and if the red MDI light is off. Therefore, the lift rules should be the same as the MDI red light.

Observations:

Faster tilt speeds make the overrun of acquired positions worse.

Loaded versus unloaded cause the tilt pressures to change drastically.

Loaded conditions will cause deflections in the upright and tires, as expected. The tilt sensor is mounted directly to the tilt cylinder. Therefore, the only change that the tilt sensor will see due to loading is the small deflection in the tilt cylinder under a higher pressure.

### End Example

Finally, one of ordinary skill in the art will recognize that additional embodiments are possible without departing from the teachings of the present invention. This detailed description, and particularly the specific details of the exemplary embodiments disclosed herein, is given primarily for clarity of understanding, and no unnecessary limitations are to be implied, for modifications will become evident to those skilled in the art upon reading this disclosure and may be made without departing from the spirit or scope of the invention. Relatively apparent modifications, of course, include combining the various features of one or more figures with the features of one or more of the other figures.

1. A lift truck, comprising:
a fork for lifting and tilting loads during use;
a mast connected to the fork that the fork follows to achieve tilting and lifting;
a first sensor on the mast to detect relatively high and low conditions of the fork above the ground;
a second sensor to detect an amount of tilting of the mast; and
a controller configured to regulate tilting speeds and tilting ranges of the mast, including restricting to lesser amounts the tilting speeds and the tilting ranges of the mast at a time whenever the first sensor detects the relatively high condition of the fork compared to a time whenever the first sensor detects the relatively low condition of the fork.

2. The lift truck of claim 1, further including an activation device and a tilt lever for the fork, wherein during use the activation device causes the mast to vertically upright upon corresponding activation of the tilt lever.

3. The lift truck of claim 2, wherein the controller is further configured to cause the mast to said vertically upright relatively slowly whenever the first sensor detects the relatively high condition of the fork compared to a time whenever the first sensor detects the relatively low condition of the fork.

4. The lift truck of claim 1, further including a tilt cylinder connected to the mast to tilt the mast upon activation of a tilt lever.

5. The lift truck of claim 4, wherein the second sensor is a linear actuator connected to the tilt cylinder.

6. The lift truck of claim 1, further including a tilt cylinder.

7. The lift truck of claim 6, wherein the lesser amounts of tilting speed are measurable in hydraulic fluid flow to the tilt cylinder in a range of about 1.5 to about 2.0 gallons per minute.

8. The lift truck of claim 1, wherein the controller is configured to tilt the mast between about five degrees backward and about three degrees forward when in the relatively high condition of the fork above the ground.

9. The lift truck of claim 1, wherein the controller is configured to tilt the mast between about eight degrees backward and about six degrees forward including a faster said tilting speed of the mast compared to a time whenever the first sensor detects the relatively high condition of the fork.

10. A lift truck, comprising
a fork for lifting and tilting loads during use;
a mast connected to the fork that the fork follows to achieve tilting and lifting;
a tilt lever for an operator to tilt the mast during use;
a tilt cylinder to mechanically tilt the mast upon activation of the tilt lever;
a change function activation device;
a first sensor on the mast to detect relatively high and low conditions of the fork above the ground;
a second sensor to detect an amount of tilting of the mast; and
a controller configured to regulate tilting speeds and tilting ranges of the mast, including causing the mast to tilt into a vertically upright position as measurable by the second sensor upon indication of activation of the change function activation device in combination with indication of forward or reverse tilting of the tilt lever.

11. The lift truck of claim 10, wherein the controller is further configured to restrict a speed of mast tilting during causation of the vertically upright position at a time whenever the first sensor detects the relatively high condition of the fork compared to a time whenever the first sensor detects the relatively low condition of the fork.

12. The lift truck of claim 10, wherein the controller is further configured to restrict to lesser amounts the tilting speeds and the tilting ranges of the mast at a time whenever the first sensor detects the relatively high condition of the fork compared to a time whenever the first sensor detects the relatively low condition of the fork.

13. A lift truck, comprising:
a fork for lifting and tilting loads during use;
a mast connected to the fork that the fork follows to achieve tilting and lifting;
a tilt lever for an operator to tilt the mast during use;
a tilt cylinder to mechanically tilt die mast upon activation of the tilt lever;
a change function activation device;
a first sensor on the mast to detect relatively high and low conditions of the fork above the ground;
a second sensor connected to the tilt cylinder to detect an amount of tilting of the mast; and
a controller configured to regulate tilting speeds and tilting ranges of the mast, including restricting to lesser amounts the tilting speeds and the tilting ranges of the mast at a time whenever the first sensor detects the relatively high condition of the fork compared to a time whenever the first sensor detects the relatively low condition of the fork and causing the mast to tilt into a vertically upright position as measurable by the second sensor upon indication of activation of the change function activation device in combination with indication of forward or reverse tilting of the tilt lever.

14. The lift truck of claim 13, wherein the controller is further configured to restrict a speed of mast tilting during causation of the vertically upright position at a time whenever the first sensor detects the relatively high condition of the fork compared to a time whenever the first sensor detects the relatively low condition of the fork.

15. The lift truck of claim 13, further including a tilt cylinder.

16. The lift truck of claim 13, wherein the lesser amounts of tilting speed are measurable in hydraulic fluid flow to the tilt cylinder in a range of about 1.5 to about 2.0 gallons per minute.

17. The lift truck of claim 13, wherein the controller is configured to tilt the mast between about five degrees backward and about three degrees forward when in the relatively high condition of the fork above the ground.

18. The lift truck of claim 13, wherein the controller is configured to tilt the mast between about eight degrees backward and about six degrees forward including a faster said tilting speed of the mast compared to a time whenever the first sensor detects the relatively high condition of the fork.

19. A method of operating a lift truck, the lift truck having a fork for lifting loads during use, a mast connected to the fork that the fork follows to achieve tilting and lifting, a tilt lever to tilt the mast, and sensors to detect heights of the fork above the ground and an amount of tilt of the mast, comprising:
detecting a height of the fork above the ground; and
based thereon, regulating tilting speeds and tilting ranges of the mast, including restricting to lesser amounts the tilting speeds and the tilting ranges of the mast whenever a sensor detects a relatively high said height of the fork compared to a time whenever the sensor detects a relatively low said height of the fork.

20. A method of operating a lift truck, the lift truck having a fork for lifting loads during use, a mast connected to the fork that the fork follows to achieve tilting and lifting, a tilt lever to tilt the mast, and sensors to detect heights of the fork above the ground and an amount of tilt of the mast, comprising:
detecting a height of the fork above the ground; and
based thereon, regulating tilting speeds and tilting ranges of the mast, including causing the mast to tilt into a vertically upright position upon indication of activation of a change function activation device in combination with indication of forward or reverse tilting of the tilt lever.

21. The method of claim 20, further including restricting a speed of mast tilting during causation of the vertically upright position whenever a sensor detects a relatively high said height of the fork compared to a time whenever the sensor detects a relatively low said height of the fork.

22. A method of operating a lift truck, the lift truck having a fork for lifting loads during use, a mast connected to the fork that the fork follows to achieve tilting and lifting, a tilt lever to tilt the mast, and sensors to detect heights of the fork above the ground and an amount of tilt of the mast, comprising:
detecting a height of the fork above the ground; and
based thereon, regulating tilting speeds and tilting ranges of the mast including,
causing the mast to tilt into a vertically upright position upon indication of activation of a change function activation device in combination with indication of forward or reverse tilting of the tilt lever, and
restricting to lesser amounts the tilting speeds and the tilting ranges of the mast whenever a sensor detects a relatively high said height of the fork compared to a time whenever the sensor detects a relatively low said height of the fork.
